(19) United States
(12) Patent Application Publication
(10) Pub. No.: US 2016/0194518 A1
(43) Pub. Date: Jul. 7, 2016

(54) ALUMINUM-RESIN COMPOSITE AND METHOD FOR PRODUCING THE SAME

(71) Applicant: SAMSUNG ELECTRONICS CO., LTD., Suwon-si (KR)

(72) Inventors: Sang Ik SON, Suwon-si (KR); A Sung KIM, Anseong-si (KR); Ho Yeon KIM, Uiwang-si (KR); Dong Soo JUNG, Suwon-si (KR)

(73) Assignee: SAMSUNG ELECTRONICS CO., LTD., Suwon-si (KR)

(21) Appl. No.: 14/851,614

(22) Filed: Sep. 11, 2015

(30) Foreign Application Priority Data
Jan. 5, 2015 (KR) 10-2015-0000909

(51) Int. Cl. C09D 177/06; C09D 167/02; C09D 181/04

(52) U.S. Cl. CPC C09D 177/06; C09D 181/04; C09D 167/02

(57) ABSTRACT

An aluminum-resin composite with an improved structure for increasing a bonding force between aluminum and resin, and a method of producing the aluminum-resin composite are provided. The aluminum-resin composite may include aluminum etched by a chemical etching solution to form an uneven surface having surface roughness of a mean projection-depression interval RSm from 50 μm to 150 μm and a maximum height Rz from 2 μm to 35 μm, and resin penetrating the uneven surface to be bonded with the aluminum.

### CROSS-REFERENCE TO RELATED APPLICATIONS

This application is related to, and claims the priority benefit of, Korean Patent Application No. 2015-0000909, filed on Jan. 5, 2015 in the Korean Intellectual Property Office, the disclosure of which is incorporated herein by reference.

### BACKGROUND

1. Field

Embodiments of the present disclosure relate to an aluminum-resin composite and a method of producing the same, and more particularly, to an aluminum-resin composite with an improved structure for increasing a bonding force between aluminum and resin, and a method of producing the aluminum-resin composite.

2. Description of the Related Art

Electronic products require more innovation in design and functions. In particular, many mobile products adopt metal materials in order to implement a refined design. However, most of metal materials cause electromagnetic interception. In order to prevent such electromagnetic interception, use of metal-resin composites has been considered. If metal-resin composites are used, functional problems such as electromagnetic interception can be overcome while achieving differentiated designs. In a metal-resin composite, a bonding force between metal and resin is one of important factors that decide the quality of a product. Accordingly, various trials for increasing a bonding force between metal and resin have been conducted.

### SUMMARY

It is an aspect of at least one embodiment to provide an aluminum-resin composite with an improved structure to increase a bonding force between aluminum and resin, and a method of producing the aluminum-resin composite.

It is an aspect of at least one embodiment to provide an aluminum-resin composite with an improved structure for improving productivity by simplifying a production process, and a method of producing the aluminum-resin composite.

Additional aspects of the disclosure will be set forth in part in the description which follows and, in part, will be obvious from the description, or may be learned by practice of the disclosure.

In accordance with an aspect of an embodiment, an aluminum-resin composite includes aluminum etched by a chemical etching solution to form an uneven surface having surface roughness of a mean projection-depression interval RSm from 50 μm to 150 μm and a maximum height Rz from 2 μm to 35 μm and resin penetrating the uneven surface to be bonded with the aluminum.

The chemical etching solution may include hydrochloric acid.

The uneven surface may have a countergradient shape.

The resin may include at least one material among polyphthalamide (PPA), polyphenylene sulfide (PPS), and polybutylene terephthalate (PBT).

In accordance with an aspect of an exemplary embodiment, a method of producing an aluminum-resin composite includes removing an oxide film formed on a surface of aluminum using a surface treating solution, forming an antioxidant protection film on the surface of aluminum removing the antioxidant protection film using an etching solution, and forming an uneven surface having surface roughness of a mean projection-depression interval RSm from 50 μm to 150 μm and a maximum height Rz from 2 μm to 35 μm on the surface of aluminum, and causing resin to penetrate the uneven surface.

The surface treating solution may include a solution containing an alkalinity source and positive metal ions.

Content of the alkalinity source may be between 25 g/L and 500 g/L.

Content of the positive metal ions may be between 2 g/L and 50 g/L.

The etching solution may include hydrochloric acid having a concentration of 35 g/L to 150 g/L.

The resin may include at least one material among polyphthalamide (PPA), polyphenylene surfide (PPS), and polybutylene terephthalate (PBT).

The uneven surface may have an irregular countergradient shape.

The method may include removing foreign materials attached on the uneven surface.

The foreign materials attached on the uneven surface may be removed by at least one process of a desmut process and an ultrasonic washing process.

The uneven surface may be immersed in nitric acid having a concentration of 300 g/L to 450 g/L by the desmut process.

The method may include anodizing the uneven surface.

The uneven surface may be anodized using at least one solution selected from among a sulfuric acid solution, a phosphoric acid solution, an oxalic acid solution, and a chromic acid solution.

The method may include forming fine uneven structures on the uneven surface.

The uneven surface may include at least one material of soluble amine and hydrazine hydrate in order to form the fine uneven structures, and the uneven surface may be treated with a solution having a pH value between pH8 and pH10.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 illustrates an example of an electronic product to which an aluminum-resin composite according to an embodiment of the present disclosure may be applied;

FIG. 2 illustrates another example of an electronic product to which an aluminum-resin composite according to an embodiment of the present disclosure may be applied;

FIG. 3 illustrates an aluminum-resin composite according to an embodiment of the present disclosure;

FIG. 4 is a flowchart illustrating aluminum treatment according to a first embodiment of the present disclosure, in a method of producing an aluminum-resin composite according to an embodiment of the present disclosure;

FIG. 5 is a flowchart illustrating aluminum treatment according to a second embodiment of the present disclosure, in a method of producing an aluminum-resin composite according to an embodiment of the present disclosure;

FIG. 6 is a flowchart illustrating aluminum treatment according to a third embodiment of the present disclosure, in a method of producing an aluminum-resin composite according to an embodiment of the present disclosure;

FIG. 7 illustrates a test aluminum-resin composite for measuring a bonding strength of an aluminum-resin composite according to an embodiment of the present disclosure;

FIG. 8 is a table showing bonding strengths of an aluminum-resin composite according to an embodiment of the present disclosure when different kinds of etching solutions are applied to the aluminum-resin composite;

FIG. 9 is a scanning electron microscope (SEM) image showing the uneven surface of first aluminum (Al 6063) subject to aluminum treatment according to the first embodiment of FIG. 4;

FIG. 10 is a SEM image showing the uneven surface of second aluminum (Al 7075) subject to aluminum treatment according to the first embodiment of FIG. 4;

FIGS. 11A to 11D are SEM images showing the uneven surface of second aluminum (Al 7075) subject to aluminum treatment according to the second embodiment of FIG. 5 over time; and

FIG. 12A is a SEM image (comparison example) showing the uneven surface of first aluminum (Al 6063) subject to aluminum treatment according to the first embodiment of FIG. 4, and FIG. 12B is a SEM image showing the uneven surface of first aluminum (Al 6063) subject to aluminum treatment according to the third embodiment of FIG. 6.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

Hereinafter, embodiments of the present disclosure are described in detail with reference to the accompanying drawings. In the following description, the terms “front end”, “back end”, “upper part”, “lower part”, “upper end”, “lower end”, etc. are defined based on the drawings, and the shapes and locations of individual components are not limited by the terms. The term “aluminum” is used as a collective name of aluminum and aluminum alloy. The unit “um” denoted in scanning electron microscope (SEM) images indicates “μm”.

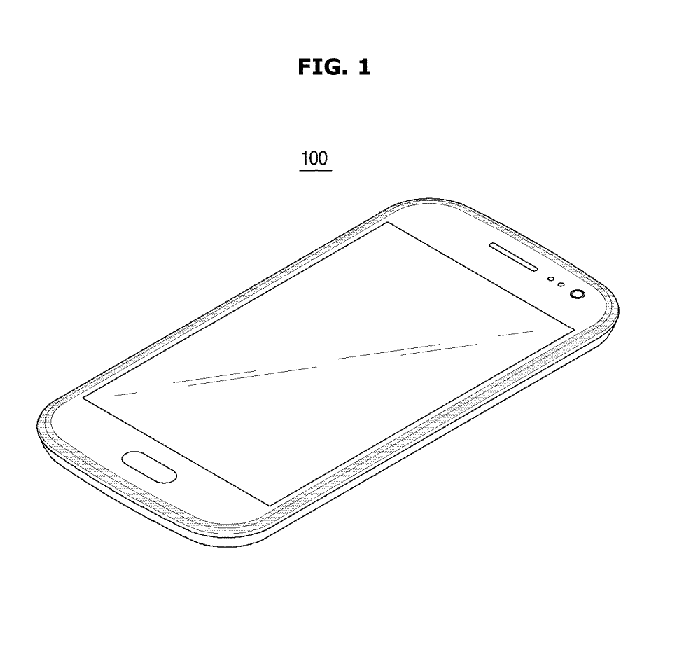

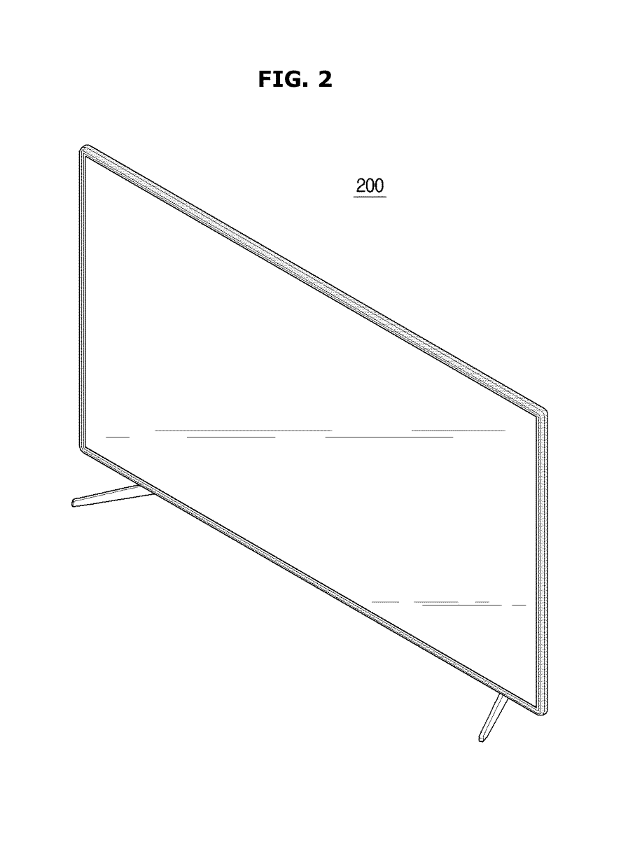

FIG. 1 illustrates an example of an electronic product to which an aluminum-resin composite according to an embodiment of the present disclosure is applied, and FIG. 2 illustrates an example of an electronic product to which an aluminum-resin composite according to an embodiment of the present disclosure is applied.

As illustrated in FIG. 1, an aluminum-resin composite 1 may be applied to the external appearance of a mobile terminal 100, for example, to implement a refined design.

As illustrated in FIG. 2, the aluminum-resin composite 1 may be applied to the external appearance of a display apparatus 200, for example, to provide a luxurious appearance with a metal material.

However, home appliances to which the aluminum-resin composite 1 can be applied may include, in addition to a the mobile terminal 100 and the display apparatus 200, various kinds of electronic products, such as a refrigerator and an air conditioner, to which a metal material can be applied, for example, for design differentiation.

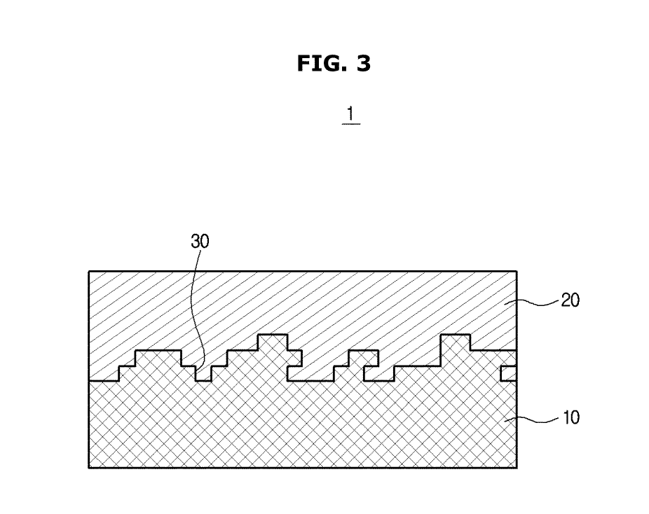

FIG. 3 illustrates the aluminum-resin composite 1 according to an embodiment of the present disclosure.

As illustrated in FIG. 3, the aluminum-resin composite 1 may include aluminum 10 and resin 20.

The term “aluminum” is used as a collective name for aluminum and aluminum alloy. The aluminum alloy may include Nos. A1000 to A7000 (corrosion-resistance aluminum alloys, high strength aluminum alloys, and heat resisting aluminum alloys) of wrought aluminum alloys specified in the Japanese Industrial Standard (JIS), and ADC1 to ADC12 (aluminum alloys for die-cast) of casting aluminum alloys. The casting alloys can be shaped to components casted by a die-cast method, or components machined after subjected to the die-cast method. The wrought alloys can be shaped to boards as intermediate products, or components machined by heat pressing of such boards.

On the aluminum 10, an uneven surface 30 may be formed. A chemical etching solution may be applied on the aluminum 10 to form an uneven surface 30 having surface roughness of a mean projection-depression interval RSm from 50 μm to 150 μm and a maximum height Rz from 2 μm to 35 μm. The mean projection-depression interval RSm and the maximum height Rz are specified in the JIS (JISB0601: 2001), and the values was obtained by measuring the uneven surface 30 using a shape measurement apparatus. The uneven surface 30 may be formed with uneven structures arranged at irregular intervals from 0.2 μm to 50 μm. The uneven surface 30 may be formed with uneven structures which can draw a roughness curve of a maximum height from 0.2 μm to 30 μm.

The uneven surface 30 may have a countergradient shape. More specifically, the uneven surface 30 may have an irregular countergradient shape.

The uneven surface 30 may be seen in the shape of cubical holes formed at intervals between 0.5 μm and 10 μm, when magnified by an electron microscope. The uneven surface 30 may be seen in the shape of cubical holes formed at intervals between 1 μm and 5 μm, when magnified by an electron microscope. If the resin 20 is injected on the uneven surface 30 when the uneven surface 30 are in the shape of cubical holes formed at intervals between 1 μm and 5 μm, a strong shear breaking force of 40 MPa or more between the aluminum 10 and the resin 20 can be obtained.

The resin 20 may penetrate the uneven surface 30 to be bonded with the aluminum 10.

More specifically, the resin 20 may penetrate the uneven surface 30 by an injection-molding method to be bonded with the aluminum 10.

The resin 20 may have fluidity to easily penetrate the cubical holes formed on the uneven surface 30 of the aluminum 10.

The resin 20 may have a high tensile strength.

The resin 20 injected on the uneven surface 30 of the aluminum 10 may penetrate the cubical holes formed in the uneven surface 30 of the aluminum 10, and solidified. The resin 20 solidified in the cubical holes formed in the uneven surface 30 of the aluminum 10 may be not easily separated from the aluminum 10. That is, the resin 20 injected on the uneven surface 30 of the aluminum 10 may be physically bonded with the aluminum 10. A complete physical bonding between the aluminum 10 and the resin 20 on the uneven surface 30 may be understood as an “anchor effect.”

Since the resin 20 solidified in the cubical holes formed on the uneven surface 30 of the aluminum 10 may be broken when a predetermined force or more is applied to the resin 20, the higher tensile strength of the resin 20, the greater shearing force of the aluminum-resin composite 1. The shearing force of the aluminum-resin composite 1 can be understood as an index of a bonding force of the aluminum-resin composite 1. The greater shearing force of the aluminum-resin composite 1 indicates the stronger bonding force between the aluminum 10 and the resin 20 of the aluminum-resin composite 1.

The resin 20 may be at least one material among polyphthalamide (PPA), polyphenylene sulfide (PPS), and polybutylene terephthalate (PBT).

The shearing force of the resin 20 may be reduced in the order of polyphthalamide (PPA), polyphenylene sulfide (PPS), and polybutylene terephthalate (PBT), and the tensile strength and fluidity of the resin 20 may also be reduced in the same order. That is, the tensile strength and fluidity of the resin 20 may be reduced in the order of polyphthalamide (PPA), polyphenylene sulfide (PPS), and polybutylene terephthalate (PBT).

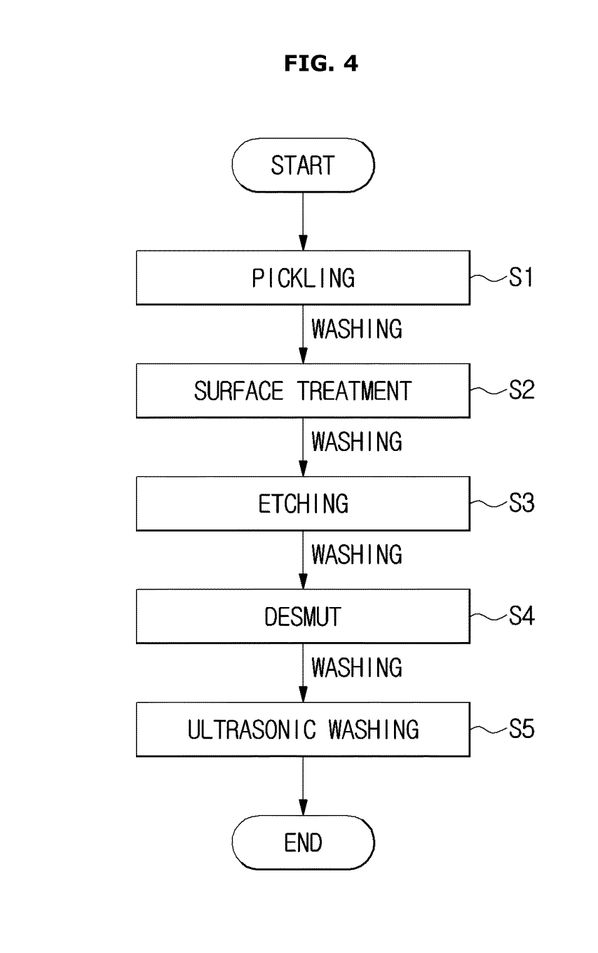

FIG. 4 is a flowchart illustrating aluminum treatment according to a first embodiment of the present disclosure, in a method of producing an aluminum-resin composite according to an embodiment of the present disclosure. The following description will be given with reference to FIGS. 3 and 4.

A method of producing the aluminum-resin composite 1 may include aluminum treatment according to a first embodiment of the present disclosure.

As illustrated in FIG. 4, the aluminum treatment according to the first embodiment of the present disclosure may include pickling S1. Through the pickling S1, foreign materials attached on the surface of the aluminum 10 may be removed. The aluminum 10 may be immersed in a degreasing tank to remove emulsions or oil attached on the surface of the aluminum 10.

In the pickling S1, an acid solution may be used. The acid solution may be nitric acid or sulfuric acid. In the pickling S1, an alkaline solution may be used to remove foreign materials from the surface of the aluminum 10.

In the pickling S1, a surfactant may be added to prevent stains such as fingerprints, and another additive may be added as necessary.

The aluminum treatment according to the first embodiment may include surface treatment S2. The surface treatment S2 may be performed to remove an oxide film formed on the surface of the aluminum 10 using a surface treating solution, and to form an antioxidant protection film on the surface of the aluminum 10.

The surface treatment S2 may be performed by at least one of immersion treatment and spray treatment. When the surface treatment S2 is performed by immersion treatment, if a treatment bath is designed according to the shape of an object to be treated, structures having complicated shapes, as well as flat plates, can also be treated.

The surface treating solution may be at a temperature between 20° C. and 40° C., and a time period for which the surface treatment S2 is performed may be between 60 seconds and 300 seconds.

The surface treating solution may be a solution containing an alkalinity source and positive metal ions.

The alkalinity source of the surface treating solution may be a sodium hydroxide solution NaOH or a potassium hydroxide solution KOH that can obtain a sufficient dissolved amount of aluminum with low cost. However, the alkalinity source of the surface treating solution is not limited to the sodium hydroxide solution NaOH and the potassium hydroxide solution KOH. The alkalinity source content in the surface treating solution may be between 25 g/L and 500 g/L.

The positive metal ions of the surface treating solution may be any ions excluding aluminum ions as long as they have a potential difference from the aluminum 10. The positive metal ions may be zinc (Zn) ions, lead (Pb) ions, tin (Sn) ions, antimony (Sb) ions, or cadmium (Cd) ions. According to an embodiment, in view of improvement of adhesion between the aluminum 10 and the resin 20 and reduction of environmental load, Zn ions and Sn ions may be preferable. According to an embodiment, Zn ions among Zn ions and Sn ions may be more preferable. The positive metal ions content in the surface treating solution may be between 2 g/L and 50 g/L.

The positive metal ions may be prepared by mixing positive metal ion sources, and added to the surface treating solution. If Zn ions are used as the positive metal ions, a positive metal ion source may be zinc nitride, zinc borate, zinc chloride, zinc sulfate, bromide zinc, basic zinc carbonate, or zinc oxide. If Sn ions are used as the positive metal ion, a positive metal ion source may be tin chloride, tin nitride, brominated tin, tin dioxide, tin oxalate, tin oxide, tin iodide, tin sulfate, tin sulfide, or tin stearate.

In the surface treatment S2, the alkalinity source in the surface treating solution may remove an oxide film formed on the surface of the aluminum 10, and the positive metal ions may perform substitution reaction with the surface of the aluminum 10 from which the oxide film has been removed to form an antioxidant protection film on the surface of the aluminum 10 in order to prevent an oxide film from being formed on the surface of the aluminum 10. The oxide film may be aluminum oxide.

In the surface treatment S2, a dissolved amount (an amount of etching in a depth direction) of aluminum may be between 0.5 μm and 15 μm when it is calculated based on the weight, specific gravity, and surface area of dissolved aluminum. When a dissolved amount of aluminum is between 0.5 μm and 3 μm, the surface area can increase while removing the oxide film, resulting in an improvement of etchability. The dissolved amount of aluminum may be adjusted by changing a treatment temperature and a treatment time.

The aluminum treatment according to the first embodiment may include etching S3. The etching S3 may be performed to remove the antioxidant protection film using an etching solution, and then to form the uneven surface 30 of the aluminum 10. By performing the etching S3, roughness differences may be made on the surface of the aluminum 10, and as a result, the aluminum 10 can be firmly physical-bonded with the resin 20. Through the etching S3, an uneven surface 30 having surface roughness of a mean projection-depression interval RSm from 50 μm to 150 μm and a maximum height Rz from 2 μm to 35 μm can be formed.

The etching solution may remove the antioxidant protection film formed in the surface treatment S2, and then etch the surface of the aluminum 10 so as to form the uneven surface 30 having a countergradient shape.

The etching solution may be a chemical etching solution. The etching solution may be hydrochloric acid (a hydrochloric acid solution). More specifically, the etching solution may be hydrochloric acid (a hydrochloric acid solution) having a concentration of 35 g/L to 150 g/L. In other words, the etching solution may be hydrochloric acid (a hydrochloric acid solution) having a concentration of 3% to 15%. The etching solution may be hydrochloric acid (a hydrochloric acid solution) having a concentration of 5% to 10%. The etching solution may be applied by at least one of immersion treatment and spray treatment. The etching solution may be at a temperature between 20° C. and 40° C., and a time period for which the etching S3 is performed may be between 20 seconds and 600 seconds.

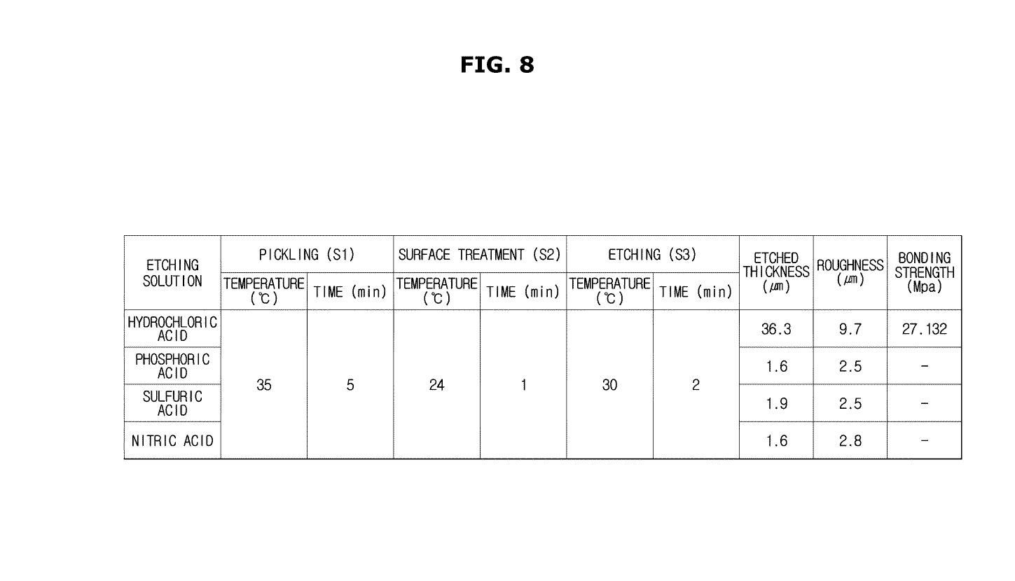

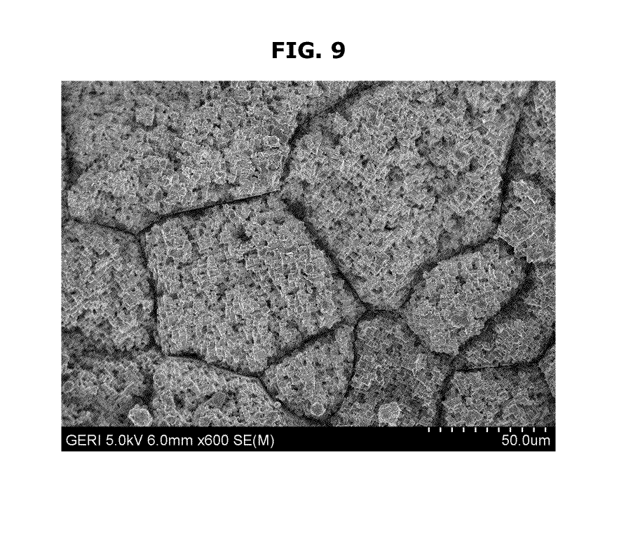

As illustrated in Table of FIG. 8, when the etching solution is hydrochloric acid (a hydrochloric acid solution), a sufficient bonding strength MPa between the aluminum 10 and the resin 20 may be ensured. When the etching solution is hydrochloric acid (a hydrochloric acid solution), a bonding strength MPa between the aluminum 10 and the resin 20 was measured as 27.132 MPa. When the etching solution is phosphoric acid (a phosphoric acid solution), sulfuric acid (a sulfuric acid solution), or nitric acid (a nitric acid solution), a target bonding strength MPa could not be ensured. Accordingly, hydrochloric acid (a hydrochloric acid solution) may be preferably used as an exemplary etching solution.

By performing the etching S3, an uneven surface 30 having a countergradient shape may be formed on the surface of the aluminum 10. A dissolved amount (an amount of etching in the depth direction) of aluminum may be between 1 μm and 50 μm when it is calculated based on the weight, specific gravity, and surface area of dissolved aluminum. When a dissolved amount of aluminum is between 5 μm and 20 μm, surface roughness of the uneven surface 30 formed by etching shows the greatest value, resulting in the greatest bonding strength MPa between the aluminum 10 and the resin 20. The dissolved amount of aluminum can be adjusted, for example, by changing a treatment temperature and a treatment time. By artificially adjusting a dissolved amount of aluminum, etching speed and stability can be adjusted. To adjust a dissolved amount of aluminum, aluminum chloride hexahydrate may be dissolved. A concentration of the aluminum chloride hexahydrate may be between 15% and 50%, and more particularly, between 35% and 45%.

The aluminum treatment according to the first embodiment may include desmut S4. The desmut S4 may be performed to remove foreign materials attached on the uneven surface 30.

Other metal components or silicon components except for aluminum not dissolved under a strong acid environment during the etching S3 may become black smut (the term “smut” is a common term used in the metal plating industry) of particles. A treatment temperature to remove such smut from the uneven surface 30 may be between 25° C. and 40° C., and a treatment time to remove such smut from the uneven surface 30 may be between 30 seconds and 300 seconds.

In the desmut S4, nitric acid (a nitric acid solution) may be used. A concentration of nitric acid (a nitric acid solution) may be between 300 g/L and 450 g/L. A concentration of nitric acid (a nitric acid solution) may be between 10% and 40%. According to an embodiment, the concentration may preferably be between 15% and 35%. In the desmut S4, the uneven surface 30 of the aluminum 10 may be immersed in the nitric acid (a nitric acid solution).

The aluminum treatment according to the first embodiment may further include ultrasonic washing S5. The ultrasonic washing S5 may be performed to remove foreign materials attached on the uneven surface 30, like the desmut S4. That is, foreign materials attached on the uneven surface 30 may be removed by at least one of the desmut S4 and the ultrasonic washing S5.

If smut is stuck in the cubical holes having the countergradient shape, it may be difficult to completely remove the smut by the desmut S4, that is, by immersing the uneven surface 30 in nitric acid (a nitric acid solution). Accordingly, according to an embodiment, the uneven surface 30 may be immersed in a water tank to which ultrasonic waves are applied to perform ultrasonic washing, thereby physically removing smut.

Between the individual operations of the aluminum treatment according to the first embodiment, washing may be performed. That is, washing may be performed after the pickling S1, the surface treatment S2, the etching S3, and the desmut S4.

The method of producing the aluminum-resin composite 1 may further include causing the resin 20 to penetrate the uneven surface 30.

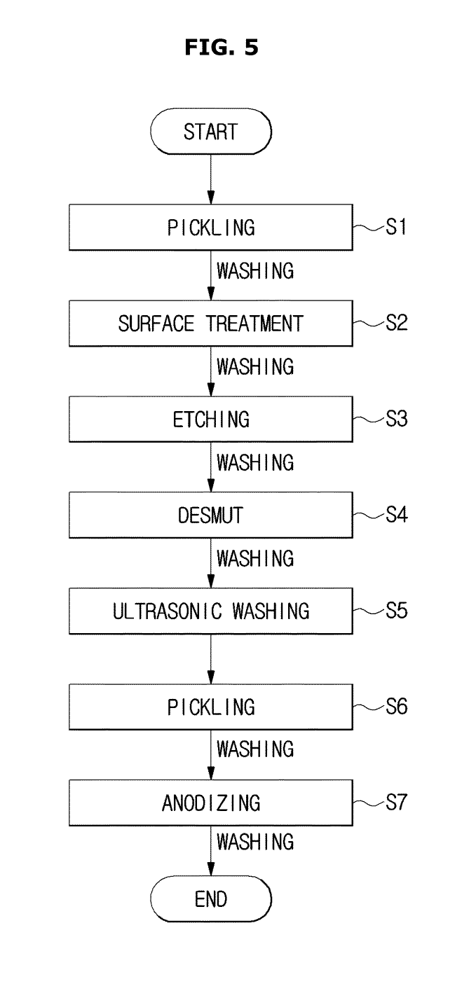

FIG. 5 is a flowchart illustrating aluminum treatment according to a second embodiment of the present disclosure, in a method of producing an aluminum-resin composite according to an embodiment of the present disclosure. The following description will be given with reference to FIGS. 3 and 5, and also, the same descriptions as those described above with reference to FIG. 4 will be omitted.

As illustrated in FIG. 5, the aluminum treatment according to the second embodiment may include the entire aluminum treatment according to the first embodiment.

The aluminum treatment according to the second embodiment may further include anodizing the uneven surface 30. That is, the aluminum treatment according to the second embodiment may include anodizing S7.

The uneven surface 30 may be anodized with at least one solution selected from among a sulfuric acid solution, a phosphoric acid solution, an oxalic acid solution, and a chromic acid solution.

The anodizing S7 may contribute to extension in surface area of the uneven surface 30 and a chemical bonding force between the aluminum 10 and the resin 20.

Since the anodizing S7 may decorate an external appearance of the aluminum-resin composite 1, the anodizing S7 may be performed after bonding of the aluminum 10 and the resin 20, that is, after causing the resin 20 to penetrate the uneven surface 30. During the anodizing S7, both the aluminum 10 and the resin 20 may be deposited in a solution for anodizing, and a part of the resin 20 may be corroded by a strong acid solution included in the solution for anodizing. The corrosion resistance of the resin 20 may increase in the order of polyphthalamide (PPA), polyphenylene sulfide (PPS), and polybutylene terephthalate (PBT). According to an exemplary test result, polybutylene terephthalate(PBT) was little influenced by such a strong acid solution. However, Nano Adhesion Technology (NAT) in forming roughness of sub microns (smaller than 1 micron) or nano scales (smaller than several tens of nano) may not obtain a sufficient bonding force between aluminum and resin having low flowability when polybutylene terephthalate (PBT) is used as the resin.

The aluminum treatment according to the second embodiment may further include pickling S6. The pickling S6 may be performed after the ultrasonic washing S5 and before the anodizing S7. The pickling S6 is performed in the same way as the pickling S1, and accordingly, further descriptions about the pickling S6 will be omitted.

After the pickling S6 and the anodizing S7, washing may be performed. That is, after the pickling S6, washing may be performed. Also, after the anodizing S7, washing may be performed.

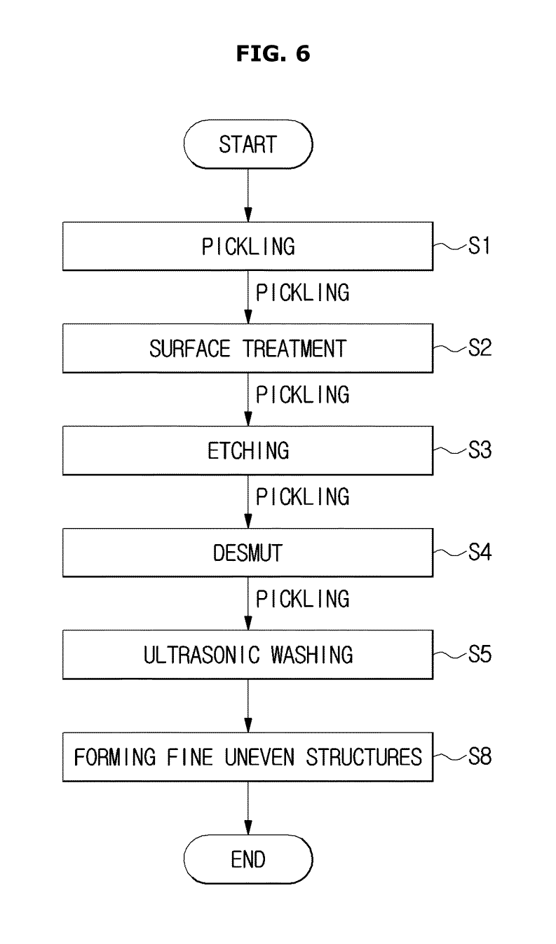

FIG. 6 is a flowchart illustrating aluminum treatment according to a third embodiment of the present disclosure, in a method of producing an aluminum-resin composite according to an embodiment of the present disclosure. The following description is given with reference to FIGS. 3 and 6, and similar descriptions as those described above with reference to FIG. 4 are be omitted.

As illustrated in FIG. 6, the aluminum treatment according to the third embodiment may include the entire aluminum treatment according to the first embodiment.

The aluminum treatment according to the third embodiment may further include operation S8 of forming fine uneven structures. The aluminum treatment according to the third embodiment may further include operation S8 of forming fine uneven structures on the uneven surface 30.

The fine uneven structures may each have a size of micro (μm) scale. The fine uneven structures may have scales that are smaller than those of the uneven structures of the uneven surface 30 formed by the etching S3.

The uneven surface 30 may be formed with at least one of soluble amine and hydrazine hydrate in order to form fine uneven structures thereon, and may be treated with a solution having a pH value between pH8 and pH10. The treatment temperature may be between 80° C. and 95° C., and the treatment time may be between 30 seconds and 300 seconds.

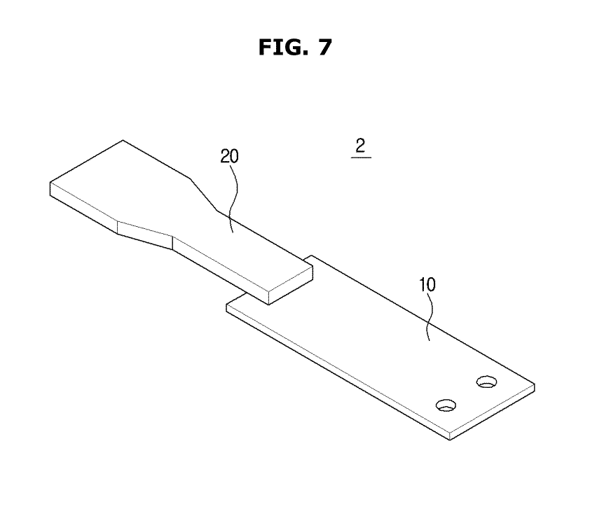

FIG. 7 illustrates a test aluminum-resin composite to measure a bonding strength of an aluminum-resin composite according to an embodiment of the present disclosure.

A test aluminum-resin composite 2 as illustrated in FIG. 7 may be formed by insert injection-molding. Aluminum 10 subjected to any one of the aluminum treatment according to the first embodiment, the aluminum treatment according to the second embodiment, and the aluminum treatment according to the third embodiment may be prepared. Thereafter, the aluminum 10 may be bonded with resin 20 through insert injection-molding. The aluminum 10 may be bonded with the resin 20 over an area of 50 mm² although the bonding area is not limited to 50 mm². After the test aluminum-resin composite 2 is completed, a bonding strength test apparatus (not illustrated) may be used to measure a bonding strength (a tensile strength) between the aluminum 10 and the resin 20.

Experimental examples of at least one embodiment are described. However, the embodiments are not limited to the described examples.

Observation through an electron microscope used a High Resolution Scanning Electron Microscope (HR-SEM) type electron microscope S-4800 (Hitachi) to observe at a voltage between 5 kV and 7 kV.

Observation through a shape measurement apparatus used a SV-3000 (Mitutoyo).

A universal testing machine TO-102 (TESTONE) was used as a bonding strength test apparatus.

A metallurgical microscope BXiS (Olympus) was used to measure an anodized section.

### Experimental Example 1 (Bonding with Aluminum Alloy Al 6063)

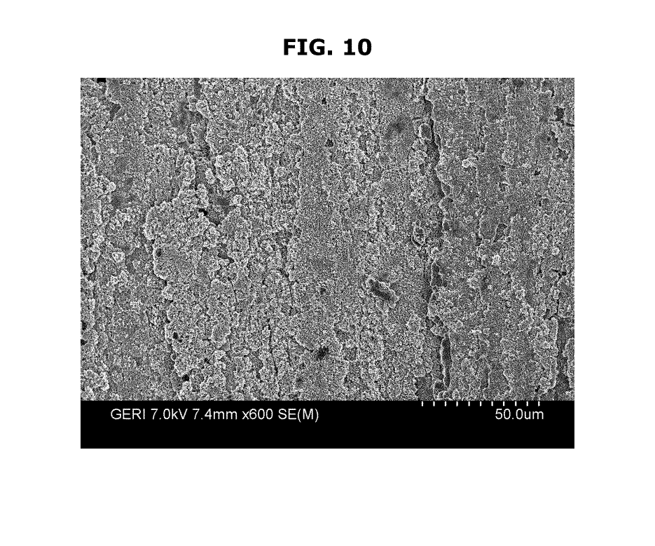

An aluminum alloy (Al 6063) board having a thickness of 1.6 mm was prepared and cut into a plurality of aluminum alloy pieces each having a rectangular shape with a size of 45 mm×18 mm. Then, water was prepared in a test bath, and a degreasing agent (Al Clean paste (BURIM Corporation)) for aluminum alloy and nitric acid were put into the water to form a solution of 5% at 50° C. The aluminum alloy pieces were immersed into the solution for 5 minutes, and then washed sufficiently. Successively, a surface treatment solution was prepared at 25° C. in another test bath, and the aluminum alloy pieces were immersed in the surface treatment solution for one minute, and then washed sufficiently. Then, a solution of hydrochloric acid with a concentration of 7% and aluminum chloride hexahydrate with a concentration of 45% was prepared at 30° C. in another test bath, and the aluminum alloy pieces were immersed in the solution for two minutes, and then washed sufficiently. Successively, a nitric acid solution with a concentration of 15% was prepared at 25° C. in another test bath, and the aluminum alloy pieces were immersed in the nitric acid solution for one minute and then washed sufficiently. Then, an ultrasonic washing bath was prepared at a room temperature, ultrasonic washing was done for three minutes, and then the aluminum alloy pieces were put into a warm-wind dryer heated to 70° C. so as to be dried for 15 minutes. Thereafter, one test piece of the aluminum alloy pieces was observed through an electron microscope. The result of the observation showed that aluminum grain boundary with a diameter of about 10 μm to 50 μm was etched more deeply than the peripheral in a depth direction, and cubes having sizes of 1 μm to 5 μm were irregularly arranged on the overall surface. A SEM image of FIG. 9 illustrates the result of the observation. Thereafter, another test piece was put on a shape measurement apparatus, and a mean projection-depression interval RSm and a maximum height Rz, specified in the JIS (JISB0601:2001), of the test piece were measured. The RSm was measured as 0.1 mm, and the Rz was measured as 35 μm. Thirty aluminum alloy pieces subject to surface treatment were taken out, and resin was injected through a horizontal injection machine (Sodick) of 140 tons, thereby obtaining a test aluminum-resin composite of FIG. 7. Thereafter, a bonding force test apparatus was used to perform a tensile failure test on the test aluminum-resin composite. To perform the tensile failure test, the bonding force test apparatus extended the test aluminum-resin composite at speed of 10 mm/min. When polyphthalamide (PPA) was used as the resin, a shear breaking force of 55 MPa was measured. When polyphenylene sulfide (PPS) was used as the resin, a shear breaking force of 40 MPa was measured. Also, when polybutylene terephthalate (PBT) was used as the resin, a shear breaking force of 30 MPa was measured.

### Experimental Example 2 (Bonding with Aluminum alloy Al 7075)

An aluminum alloy (Al 7075-T6) board having a thickness of 1.6 mm was prepared, and the same test as described above in Experimental Example 1 was performed. When a test piece was observed through an electron microscope, the result of the observation showed that aluminum grain boundary was not clearly distinguished, and irregular uneven surfaces and irregular holes were distributed. The irregularly distributed holes were measured as various sizes of 0.5 μm through 10 μm. A SEM image of FIG. 10 illustrates the result of the observation. Thereafter, another test piece was put on a shape measurement apparatus, and RSm and Rz of the test piece were measured. The RSm was measured as 0.09 mm, and the Rz was measured as 12 μm. Ten aluminum alloy pieces subject to surface treatment were taken out, and polybutylene terephthalate (PBT) was injected through a horizontal injection machine (Sodick) of 140 tons, thereby obtaining a test aluminum-resin composite of FIG. 7. Thereafter, the bonding force test apparatus was used to perform a tensile failure test on the test aluminum-resin composite. In order to perform the tensile failure test, the bonding force test apparatus extended the test aluminum-resin composite at speed of 10 mm/min. At this time, a very strong mean shear breaking force of 30 MPa was measured.

### Experimental Example 3 (Bonding with Aluminum Alloy Al 7075 Anodizing)

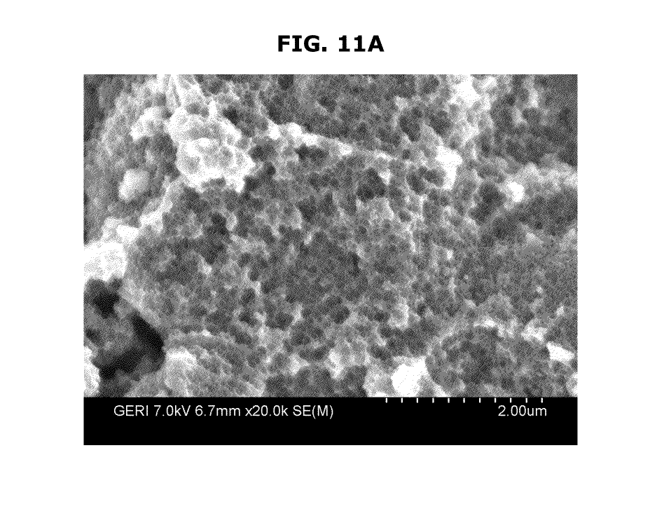

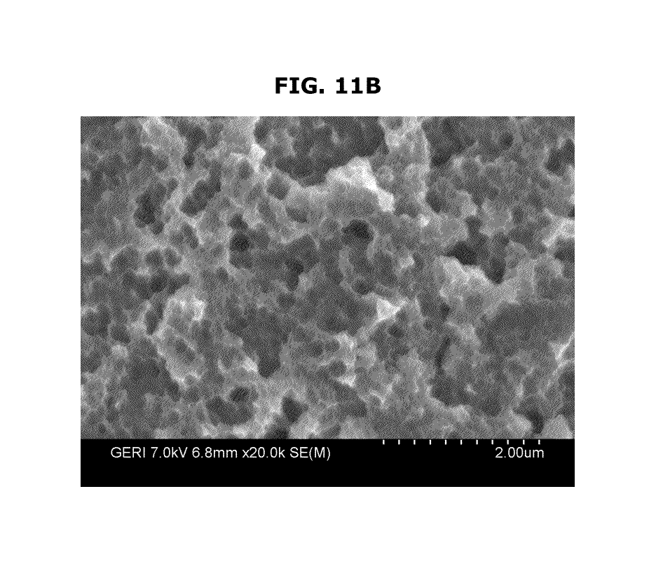

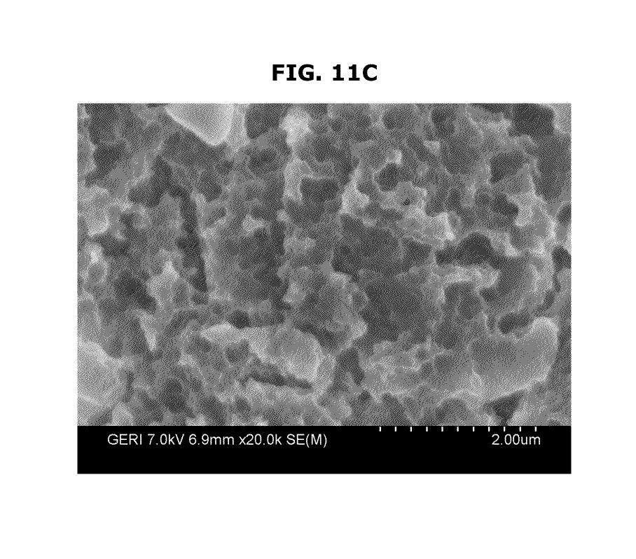

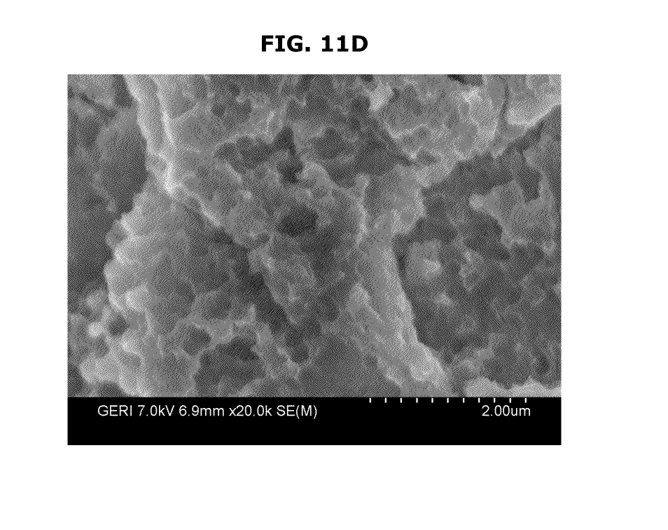

An aluminum alloy (Al 7075-T6) board having a thickness of 1.6 mm was prepared, and the same test as described above in Experimental Example 1 was performed excluding drying. In addition, general anodizing was applied in such a manner to apply a constant voltage of 13V to a sulfuric acid solution with a concentration of 20% at 20° C., and the aluminum alloy pieces were immersed for two minutes, for 10 minutes, and for 30 minutes. Successively, a washing bath was prepared at a room temperature, and the aluminum ally pieces were washed in the washing bath. Then, the aluminum alloy pieces were put into a warm-wind dryer heated to 70° C. to be dried for 15 minutes. Thereafter, one test piece of the aluminum alloy pieces immersed for different times was observed through an electron microscope. The result of the observation showed that holes having diameters of about 5 nm through about 10 nm were formed on the surface of aluminum from when the immersion time of 10 minutes elapsed. As the anodizing time increased, an oxide film was grown on the surface, and cubical holes formed by etching were gradually filled with the grown oxide film. SEM images of FIGS. 11A to 11D show the results of the observation. FIG. 11A, which is a comparison example, illustrates second aluminum (Al 7075) subject to the aluminum treatment according to the first embodiment. FIG. 11B illustrates aluminum when the immersion time of two minutes elapsed. FIG. 11C illustrates aluminum when the immersion time of 10 minutes elapsed, and FIG. 11D illustrates aluminum when the immersion time of 30 minutes elapsed. Thereafter, the section of the test piece was observed through an optical microscope. The result of the observation showed that an oxide film of 0.5 μm through 3 μm was formed, and the oxide film was grown to fill the cubical holes to flatten the uneven surfaces as the immersion time increased. Aluminum alloy pieces subject to surface treatment were taken out, and polybutylene terephthalate (PBT) was injected through a horizontal injection machine (Sodick) of 140 tons, thereby obtaining a test aluminum-resin composite of FIG. 7. Thereafter, the bonding force test apparatus was used to perform a tensile failure test on the test aluminum-resin composite. In order to perform the tensile failure test, the bonding force test apparatus extended the test aluminum-resin composite at speed of 10 mm/min. As the test result, a bonding force of 33 MPa increased by about 2 MPa to 3 MPa compared to Experimental Example 2 was measured, and the bonding force decreased as the immersion time increased. In Experimental Example 2, cubical holes having countergradient shapes due to etching were formed to ensure an aluminum-resin bonding force due to the anchor effect, whereas in Experimental Example 3, an aluminum oxide film was formed on the surface formed in Experimental Example 2 to provide an adhesion force of gel type to the surface, which contributed to an increase of a bonding force. The phenomenon that the bonding force was lowered according to elapse of time may be expected because the formed oxide film filled the cubical holes formed by etching so as to prevent resin from penetrating.

### Experimental Example 4 (Bonding with Aluminum Alloy Al 6063_Formation of Fine Uneven Structures)

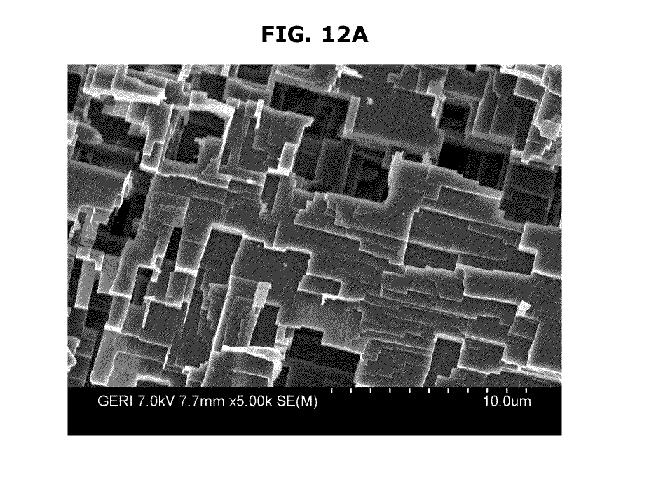

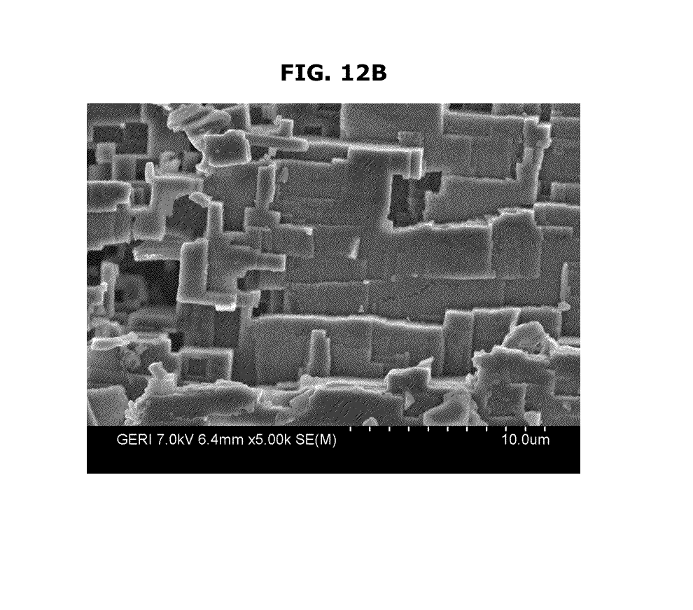

An aluminum alloy (Al 6063) board having a thickness of 1.6 mm was prepared, and the same test as described above in Experimental Example 1 was performed excluding drying. In addition, triethylamine (TEA) was added to a test bath storing distilled water heated to 90° C. to form a solution of pH9. Then, the test pieces were immersed in the solution for about two minutes. Successively, a washing bath was prepared at a room temperature. The test pieces were washed in the washing bath and then put into a warm-wind dryer heated to 70° C. so as to be dried for 15 minutes. Thereafter, one test piece of the test pieces was observed through an electron microscope. The result of the observation showed that fine protrusions were formed on the surfaces of cubical holes formed by etching. A SEM image of FIG. 12B illustrates the result of the observation. FIG. 12A, which is a comparison example, illustrates the uneven surface of first aluminum (Al 6063) subject to the aluminum treatment according to the first embodiment. The aluminum alloy pieces subject to surface treatment were taken out, and polybutylene terephthalate (PBT) was injected through a horizontal injection machine (Sodick) of 140 tons, thereby obtaining a test aluminum-resin composite of FIG. 7. Thereafter, the bonding force test apparatus was used to perform a tensile failure test on the test aluminum-resin composite. In order to perform the tensile failure test, the bonding force test apparatus extended the test aluminum-resin composite at speed of 10 mm/min. As the test result, a bonding force of 32 MPa increased by about 2 MPa compared to Experimental Example 1 was measured.

According to at least one of the embodiments as described above, by forming an uneven surface having a countergradient shape on aluminum, instead of using adhesive, it is possible to increase a bonding force between aluminum and resin.

According to at least one of the embodiments, by using an injection molding method to cause resin to penetrate the uneven surface of aluminum, it is possible to increase a bonding force between aluminum and resin, and to improve the productivity of aluminum-resin composites.

According to at least one of the embodiments, by limiting use of a surface treatment chemical agent such as fluorine for providing a bonding force (an adhesive strength) to the surface of aluminum, it is possible to minimize environmental pollution.

According to at least one of the embodiments, by adjusting the shape and size of the uneven surface having a countergradient shape, it is possible to improve penetrability of resin, resulting in an improvement of a physical bonding force between aluminum and resin.

Although a few embodiments of the present disclosure have been illustrated and described, it would be appreciated by those skilled in the art that changes may be made in these embodiments without departing from the principles and spirit of the disclosure, the scope of which is defined in the claims and their equivalents.

What is claimed is:

1. An aluminum-resin composite comprising:
aluminum with an uneven surface having surface roughness of a mean projection-depression interval RSm from 50 μm to 150 μm and a maximum height Rz from 2 μm to 35 μm; and
resin penetrating the uneven surface to be bonded with the aluminum.

2. The aluminum-resin composite according to claim 1, wherein the uneven surface of the aluminum is formed by etching by a chemical etching solution comprising hydrochloric acid.

3. The aluminum-resin composite according to claim 1, wherein the uneven surface has a countergradient shape.

4. The aluminum-resin composite according to claim 1, wherein the resin comprises at least one material among polyphthalamide (PPA), polyphenylene sulfide (PPS), and polybutylene terephthalate (PBT).

5. A method of producing an aluminum-resin composite, comprising:
removing an oxide film formed on a surface of aluminum using a surface treating solution, and forming an antioxidant protection film on the surface of aluminum; and
removing the antioxidant protection film using an etching solution, and forming an uneven surface having surface roughness of a mean projection-depression interval RSm from 50 μm to 150 μm and a maximum height Rz from 2 μm to 35 μm on the surface of aluminum; and
causing resin to penetrate the uneven surface.

6. The method according to claim 5, wherein the surface treating solution comprises a solution containing an alkalinity source and positive metal ions.

7. The method according to claim 6, wherein an amount of the alkalinity source is between 25 g/L and 500 g/L.

8. The method according to claim 6, wherein an amount of the positive metal ions is between 2 g/L and 50 g/L.

9. The method according to claim 5, wherein the etching solution comprises hydrochloric acid having a concentration of 35 g/L to 150 g/L.

10. The method according to claim 5, wherein the resin comprises at least one material among polyphthalamide (PPA), polyphenylene sulfide (PPS), and polybutylene terephthalate (PBT).

11. The method according to claim 5, wherein the uneven surface has an irregular countergradient shape.

12. The method according to claim 5, further comprising removing foreign materials attached on the uneven surface.

13. The method according to claim 12, wherein the foreign materials attached on the uneven surface are removed by at least one process of a desmut process and an ultrasonic washing process.

14. The method according to claim 13, wherein the uneven surface is immersed in nitric acid having a concentration of 300 g/L to 450 g/L by the desmut process.

15. The method according to claim 5, further comprising anodizing the uneven surface.

16. The method according to claim 15, wherein the uneven surface is anodized using at least one solution selected from among a sulfuric acid solution, a phosphoric acid solution, an oxalic acid solution, and a chromic acid solution.

17. The method according to claim 5, further comprising forming fine uneven structures on the uneven surface.

18. The method according to claim 17, wherein the uneven surface comprises at least one material of soluble amine and hydrazine hydrate in order to form the fine uneven structures, and the uneven surface is treated with a solution having a pH value between pH8 and pH10.
